(19) United States
(12) Patent Application Publication
(10) Pub. No.: US 2026/0147327 A1
(43) Pub. Date: May 28, 2026

(54) MACHINING COMMAND CORRECTION DEVICE AND MACHINING COMMAND CORRECTION METHOD

(71) Applicant: FANUC CORPORATION, Minamitsuru-gun, Yamanashi (JP)

(72) Inventor: Kiwamu SAITOU, Minamitsuru-gun, Yamanashi (JP)

(21) Appl. No.: 19/104,792

(22) PCT Filed: Oct. 21, 2022
(86) PCT No.: PCT/JP2022/039366

§ 371 Date: Jan. 6, 2026

(51) Int. Cl. G05B 19/404

(52) U.S. Cl. CPC G05B 19/404; G05B 2219/35012; G05B 2219/37506

(57) ABSTRACT

A machining command correction device includes a machining command analyzing unit that generates first machine coordinate information based on a first machining command and machine configuration information, a tool orientation correcting unit that corrects the orientation of a tool based on the first machine coordinate information and generates second machine coordinate information, and an interference calculating unit that calculates interference between the tool and a workpiece based on the second machine coordinate information, the machine configuration information, tool shape information, and workpiece shape information. The machining command correction device also includes a machining command generating unit that, when there is no interference, generates a second machining command based on the second machine coordinate information. The tool orientation correcting unit uses an evaluation value in which the quality of the tool path is evaluated, and determines the orientation of the tool after the correction.

### TECHNICAL FIELD

The present disclosure relates to a machining command correction device and a machining command correction method that correct a machining command for controlling a machine tool and, in particular, to a machining command correction device and a machining command correction method that correct a machining command for changing an orientation of a tool relative to a workpiece.

### BACKGROUND ART

Patent Document 1 describes a tool path generation method and a tool path generation device for machining a surface of a workpiece using a machine tool having at least one rotary feed axis while changing the tool orientation of an end mill relative to the workpiece. Specifically, Patent Document 1 describes the following: one machining point is set, as a point to be machined, on a plurality of tool path rows; machining points located within a predetermined range are selected as machining points of interest, where the predetermined range has the point to be machined at its center; a tool orientation at the point to be machined is calculated by averaging tool orientations at the selected machining points of interest; data related to a tool orientation at the point to be machined is corrected using the calculated average tool orientation; shape data of the workpiece to be machined and shape data of the ball end mill to be used are acquired; an interference check is performed between the workpiece and the ball end mill on the basis of the corrected tool orientation data; and, if there is no interference between the workpiece and the ball end mill, a new tool path is generated based on data related to the corrected tool orientation.

### CITATION LIST

### Patent Document

Patent Document 1: Domestic re-publication of PCT international application WO 2018/179401

### DISCLOSURE OF THE INVENTION

### Problems to be Solved by the Invention

In Patent Document 1, an interference check is performed between the workpiece and the ball end mill on the basis of the corrected tool orientation data, and if there is no interference between the workpiece and the ball end mill, a new tool path is generated based on the data related to the corrected tool orientation. In the case of changing a tool orientation, it is desired that a tool path obtained after the change in the tool orientation does not become less favorable than the tool path obtained before the change in the tool orientation.

Therefore, there has been a demand for a machining command correction device and a machining command correction method that optimize a tool orientation without allowing a tool path obtained after a change in the tool orientation to be less favorable than a tool path obtained before the change in the tool orientation and within a range in which no interference occurs.

### Means for Solving the Problems

In a representative first aspect of the present disclosure, a machining command correction device includes: a machining command analyzing unit configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; a tool orientation correcting unit configured to correct the orientation of the tool on the basis of the first machine coordinate information and generate second machine coordinate information; an interference calculating unit configured to calculate an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and a machining command generating unit configured to generate, when the interference does not exist, a second machining command on the basis of the second machine coordinate information, wherein the tool orientation correcting unit determines a corrected orientation of the tool by using an evaluation value for evaluating quality of a tool path.

In a representative second aspect of the present disclosure, a machining command correction device includes: a machining command analyzing unit configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; an interference calculating unit configured to calculate an interference between the tool and the workpiece for a case in which the machine tool operates in accordance with the first machine coordinate information, on the basis of the first machine coordinate information, the machine configuration information, tool shape information related to a shape of the tool for use in machining to be performed in accordance with the first machining command, and workpiece shape information related to a shape of the workpiece to be achieved when the first machining command is performed; a tool orientation correcting unit configured to correct the orientation of the tool on the basis of the first machine coordinate information and generate second machine coordinate information; and a machining command generating unit configured to generate, when the interference does not exist, a second machining command on the basis of the second machine coordinate information, wherein the interference calculating unit calculates a tool orientation range in which an interference does not occur, and the tool orientation correcting unit corrects the orientation of the tool within the tool orientation range that has been calculated, and determines a corrected orientation of the tool by using an evaluation value for evaluating quality of a tool path.

In a representative third aspect of the present disclosure, a machining command correction method including causing a computer as a machining command correction device to perform processing that includes: generating first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; correcting the orientation of the tool on the basis of the first machine coordinate information and generating second machine coordinate information; calculating an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and generating, when the interference does not exist, a second machining command on the basis of the second machine coordinate information.

### BRIEF DESCRIPTION OF THE DRAWINGS

FIG. 1 is a block diagram showing a configuration of a data generation system.

FIG. 2 is a diagram showing a flow of data generation in the data generation system.

FIG. 3 is a block diagram showing a configuration of a machining command correction device according to a first embodiment of the present disclosure.

FIG. 4 is a diagram showing information on types of machine configurations.

FIG. 5 is a diagram for describing information of the positions of the center of a rotary axis and a workpiece coordinate system.

FIG. 6 is a diagram showing a situation where, while the center position of a spherical shape of a ball end mill is fixed in place, the tool's orientation is changed within a certain range.

FIG. 7 is a characteristic diagram showing an example of first machine coordinate information.

FIG. 8 is a diagram showing machine coordinates before and after coordinate values for a rotary axis are changed at each command point in a correction section.

FIG. 9 is a characteristic diagram showing an amount of change of an axis (which is a drive axis represented by axis in Expression 1) (ΔLaxis (pi)).

FIG. 10 is a diagram showing an example of parameter information for each height of a tool and a radius at each height.

FIG. 11 is a diagram showing CAD data as an example of workpiece shape information.

FIG. 12 is a flowchart showing an operation of the machining command correction device.

FIG. 13 is a block diagram showing a configuration of a machining command correction device according to a first modification example of the first embodiment of the present disclosure.

FIG. 14 is a block diagram showing a configuration of a machining command correction device according to a second modification example of the first embodiment of the present disclosure.

FIG. 15 is a diagram showing a region calculated by an interference calculating unit, where a tool shape has an interference with a workpiece in the region.

FIG. 16 (A) is a diagram showing an example of generating new tool shape information by increasing an amount of protrusion of a tool.

FIG. 16 (B) is a diagram showing an example of generating new tool shape information by reducing a diameter of a tooling portion in the tool shape information.

FIG. 17 is a diagram showing a case in which an interference region is eliminated, and there is no interference.

FIG. 18 is a block diagram showing a configuration of a machining command correction device according to a third modification example of the first embodiment of the present disclosure.

FIG. 19 is a block diagram showing a configuration of a machining command correction device according to a second embodiment of the present disclosure.

FIG. 20 is a diagram showing a range in which a tool orientation can be changed without causing an interference.

### PREFERRED MODE FOR CARRYING OUT THE INVENTION

Prior to the description of embodiments according to the present disclosure, a flow of data generation is described for a data generation system that generates data for controlling a machine tool. The machining command correction device according to the present disclosure can be applied to the data generation system.

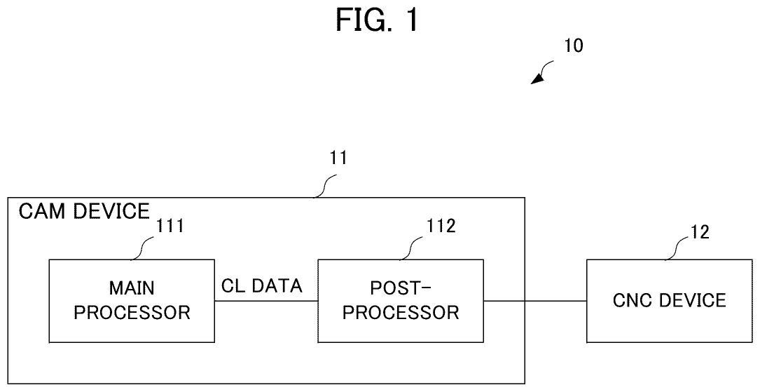

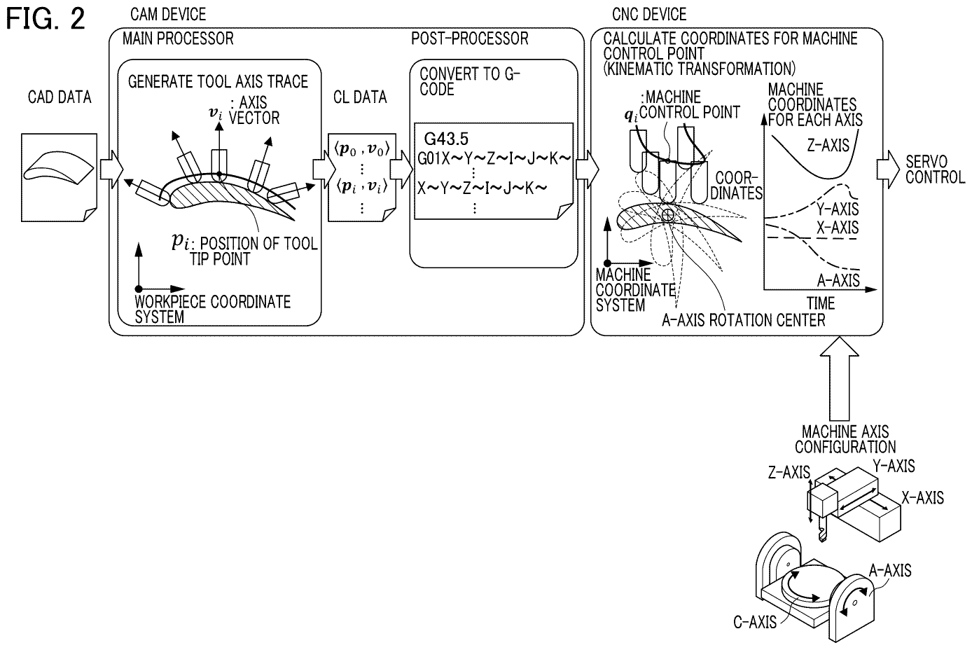

FIG. 1 is a block diagram showing a configuration of the data generation system. FIG. 2 is a diagram showing a flow of data generation in the data generation system. As shown in FIG. 1, a data generation system 10 includes a CAM device 11 and a CNC device 12. The CAM device 11 includes a main processor 111 and a post-processor 112.

The main processor 111 of the CAM device 11 generates a tool path drawing on the basis of shape data of a workpiece (CAD data) created by a CAD device (not shown). A tool path drawing refers to time-series data of the position and orientation of a tool (tool axis vectors) and may also include a feed speed or movement methods (linear movement, arc movement) from a previous position.

A tool path drawing generated by the main processor 111 represents a generic command independent of the type of machine tool. It is not generated for a specific configuration of machine axes and the like to be used for machining and thus, a tool path drawing generated by the CAM device 11 is not necessarily optimal for controlling the machine.

The tool path drawing generated by the main processor 111 is converted by the post-processor 112 to a machining program fit for an individual machine. The post-processor 112 performs insertion and the like of instructions usable by the machine (rotate the spindle, turn ON/OFF cutting fluid, and the like) but the post-processor 112 does not perform operations such as changing a tool path drawing.

The CNC device 12 performs, from the machining program, calculation (hereinafter referred to as kinematic transformation) of time-series data of coordinates of a machine control point with respect to the machine coordinate system (hereinafter referred to as machine coordinate information). Each motor of the machine tool is controlled based on the machine coordinate information. A machine control point is used for calculation of coordinates for a linear axis. The machine control point is a point fixed on the machine and its position does not change when a rotary axis is moved. The machine control point is shown, for example, in FIG. 2.

The position and acceleration/deceleration of a motor are calculated from the coordinates of the machine control point. Thus, if the route of the machine control point is not smooth, axis acceleration and deceleration increase, which will be a factor in reducing the machining speed or in increasing the power consumption. Moreover, vibration caused by axis acceleration/deceleration may degrade a machined surface. If a tool orientation is corrected within the CNC device 12 to smoothen the machine control points, an interference may occur between the tool and the workpiece, and a greater amount of change in tool orientation results in a greater risk of interference. To avoid an interference, the tool orientation can be changed by only a very small amount that poses only a small risk of interference. Thus, the effect of smoothening the machine operation by correcting the tool orientation will be limited. Therefore, it is desired to check for an interference between the tool and the workpiece and optimize the tool orientation within a range in which no interference occurs.

Furthermore, it is desired that, when the tool orientation is changed, the tool path obtained after the change in the tool orientation does not become less favorable than the tool path obtained before change in the tool orientation; for example, it is desired that an issue such as an increased amount of axis movement is not caused. Embodiments and modification examples of the present disclosure described below relate to a machining command correction device and a machining command correction method that optimize a tool orientation without making a tool path obtained after a change in a tool orientation, less favorable than a tool path obtained before the change in the tool orientation, and within a range in which an interference does not occur.

Some embodiments of the present disclosure are described below in detail with reference to the drawings.

### First Embodiment

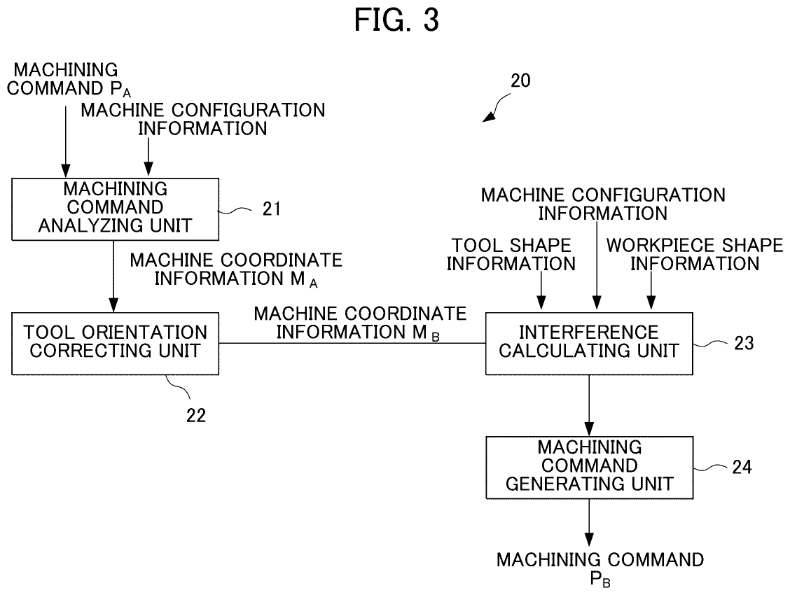

FIG. 3 is a block diagram showing a configuration of a machining command correction device according to a first embodiment of the present disclosure. As shown in FIG. 3, a machining command correction device 20 includes a machining command analyzing unit 21, a tool orientation correcting unit 22, an interference calculating unit 23, and a machining command generating unit 24. The machining command correction device 20 may be installed in the CAM device 11 or in the CNC device 12 shown in FIG. 1. Alternatively, the machining command correction device 20 may be a separate device from the CAM device 11 and the CNC device 12.

Each constituent element of the machining command correction device is described below.

### (Machining Command Analyzing Unit)

The machining command analyzing unit 21 generates first machine coordinate information MA, which is related to machine coordinates for each control axis of a machine tool on the basis of a first machining command PA, which is a pre-compensation machining command, and machine configuration information. The first machining command PA includes data describing time-series change in position and orientation of the tool described with respect to the workpiece coordinate system. Calculation (the kinematic transformation) to obtain coordinates for each control axis of the machine, which is to be included in the first machine coordinate information MA, from the position and orientation of the tool described with respect to the workpiece coordinate system (included in the first machining command PA) by using the machine configuration information is a publicly known technique.

The first machining command PA is information describing, for example, time-series data of the position and orientation of the tool (tool axis direction vectors) with respect to the workpiece coordinate system and movement methods (linear movement, arc movement, and the like) from the previous position. The first machining command PA may include information on the tool moving speed and the spindle rotation number. The first machining command PA refers to, for example, a file of a character string described using G-code included in the machining program, or a file in a CAM device specific format, referred to as CL data. However, the first machining command PA may be in any format as long as it includes time-series data of the position and orientation of a tool with respect to the workpiece coordinate system, information describing the movement method from the previous position, and the like. For example, the first machining command PA may be binary data or the like.

If the machine coordinate information is generated, for example, between the main processor 111 and the post-processor 112 of the CAM device 11, the CL data is used as the first machining command PA. If the machine coordinate information is generated between the post-processor 112 and the CNC device 12, a file of G-code is used as the first machining command PA. If the machine coordinate information is generated while the kinematic transformation is performed within the CNC device 12 after the file of G-code is input to the CNC device 12, binary data having a CNC device 12 internal format is used as the first machining command PA.

The machine configuration information is information for performing a coordinate transformation between the coordinate system having a workpiece as its reference and the coordinate system having the machine tool as its reference. When the machine configuration information is used to generate the machine coordinate information, the machine configuration information is needed to perform conversion (the kinematic transformation) of the position and orientation of the tool described with respect to the workpiece coordinate system to coordinates for each axis of the machine. The machine configuration information is also used to perform an inverse kinematic transformation to be described below.

The machine configuration information includes, for example, the following information.

### (1) Information on the Type of Configuration of the Machine

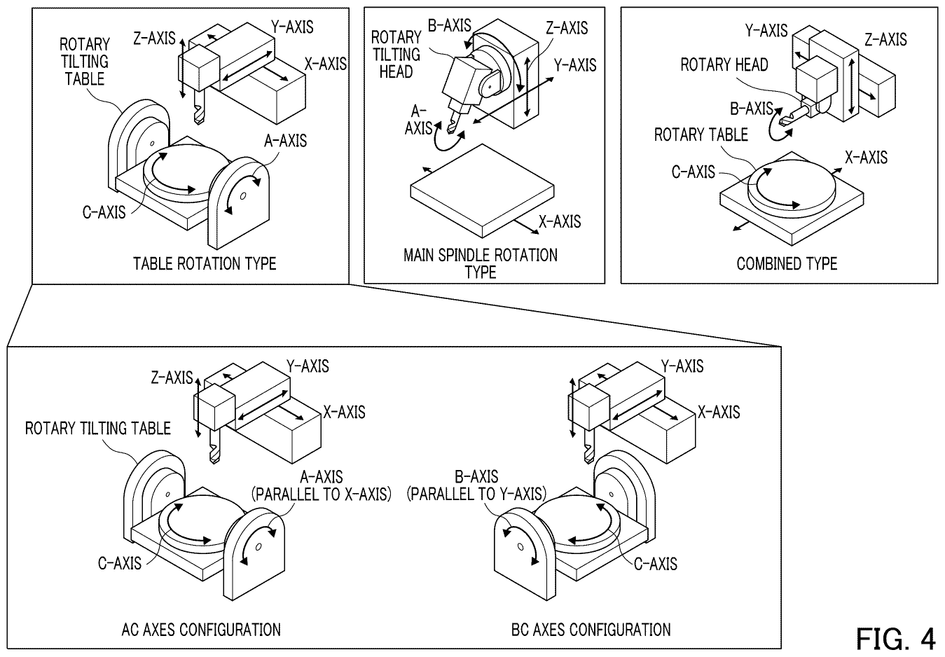

The information on the type of machine configuration is, for example, information indicative of whether the machine tool is a four-axis machine or a five-axis machine, information indicative of whether the axis configuration is a table rotation type, a spindle rotation type, or a hybrid of the table rotation type and the spindle rotation type, and information indicative of whether the directions of the rotary axes of the table rotation type is an AC-axis configuration or a BC-axis configuration. FIG. 4 is a diagram showing the configurations of the table rotation type, the spindle rotation type, and the hybrid type, and the AC-axis configuration and the BC-axis configuration for the table rotation type.

### (2) Information on the Positions of a Rotary Axis Center and the Workpiece Coordinate System

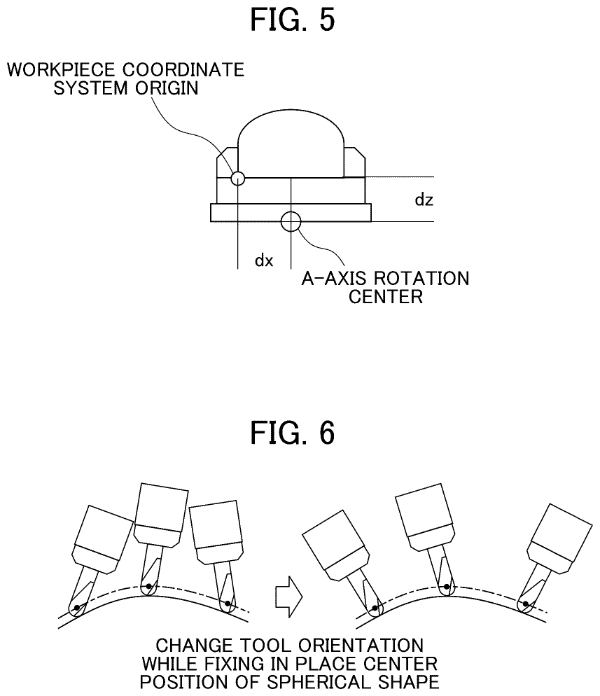

FIG. 5 is a diagram for describing the information of the positions of the rotary axis center and the workpiece coordinate system. FIG. 5 shows an A-axis rotation center and a workpiece coordinate system origin, showing that the difference between the A-axis rotation center and the workpiece coordinate system origin is a difference dx in an X-direction and dz in a z-direction.

### (Tool Orientation Correcting Unit)

The tool orientation correcting unit 22 corrects the orientation of the tool and generates a second machine coordinate information MB on the basis of the first machine coordinate information MA generated by the machining command analyzing unit 21. Example methods for correcting a tool orientation are described below.

(A) when Machining is Performed Using a Ball End Mill

A ball end mill has a tip portion having a spherical shape; thus, as shown in FIG. 6, changing the tool's orientation within a certain range while fixing in place the center position of the spherical shape of the ball end mill results in no change in the post-machining shape. Hence, for correction of the tool orientation, only the orientation of the tool is changed without changing the position of the center of the ball with respect to the workpiece coordinate system. In the case of the tool shown in FIG. 6, changing its orientation for 90 degrees or more brings a tubular portion of the tool into contact with the workpiece, resulting in a change in the post-machining shape. This, however, can be avoided by setting an upper limit to the amount of change in the tool orientation.

(B) When the First Machine Coordinate Information MA Includes a Time Period when a Tool Orientation should not be Corrected and a Time Period when a Tool Orientation can be Corrected

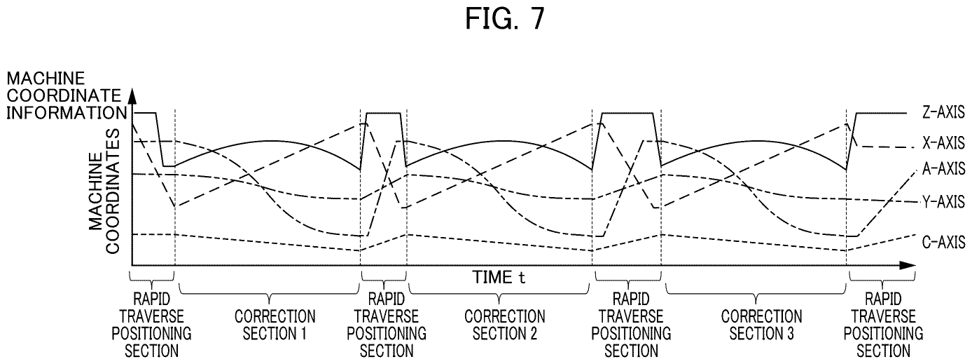

The first machine coordinate information MA may include movement for which a tool orientation should not be corrected, such as a rapid traverse positioning movement. For this reason, the tool orientation correcting unit 22 extracts, from the first machine coordinate information MA, a correction section in which a tool orientation can be corrected. An example correction section includes a cutting feed section made up using a continuous polygonal line segment. There may be a plurality of correction sections. FIG. 7 is a characteristic diagram showing an example of the first machine coordinate information. As shown in FIG. 7, the first machine coordinate information MA includes four rapid traverse positioning time periods and three correction time periods for an X-axis, a Y-axis, a Z-axis, an A-axis, and a C-axis. The four rapid traverse positioning time periods are time periods in which a tool orientation should not be corrected, and the three correction time periods are time periods in which a tool orientation can be corrected.

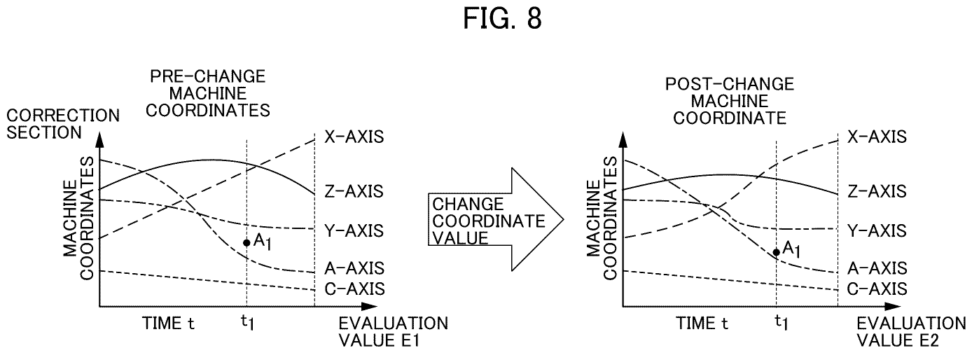

The tool orientation correcting unit 22 corrects a tool orientation in each of the correction sections shown in FIG. 7 in a manner described below. The tool orientation correcting unit 22 calculates an evaluation value E1 for a pre-compensation tool path in each extracted correction section by using a calculation method described below. Then, coordinate values for a rotary axis at each command point in the correction section are changed. Here, if a limit is set to the amount of change in the orientation, the post-change coordinates for the rotation angle are determined so that an orientation change does not exceed the limit. For example, if there is an upper limit of A1 for the A-axis machine coordinate at time t1 in FIG. 8, post-change rotary axis coordinates are determined so that the A-axis coordinate does not exceed A1 at time t1. Determining the rotary axis coordinates determines the linear axis coordinate values from the condition that “the coordinates for the center of the ball with respect to the workpiece coordinate system do not change”. It is desirable that tool orientations are not changed at the first and last command points in a correction section so that the tool orientation does not change abruptly at the boundary between a preceding section and a subsequent section. Furthermore, an abrupt speed change at the boundary between sections may be prevented by making no change to the speed of each axis at the first and last points in the correction section.

The tool orientation correcting unit 22 calculates the evaluation value E2 for a tool path obtained after the change in the tool orientation. If the evaluation value E2 is better than the evaluation value E1, the tool path obtained after the change in the tool orientation is chosen as post-correction machine coordinate information. Post-correction machine coordinate information does not necessarily have to be calculated after one change. For instance, an amount of compensation is added to rotary axis coordinates to change a tool path, and if the evaluation of the post-change tool path is better than that of the pre-change tool path, the change is chosen. If the evaluation of the post-change tool path is less favorable than that of the pre-change tool path, the change is canceled, and a different amount of compensation is added to change the tool path. A task of further adding an amount of compensation to the chosen tool path to change the tool path may be repeated. A reiterated search conducted in this way may be used to obtain a tool path having the best index value. Processing of correcting a tool path can be considered as multi-variable optimization, where rotary axis coordinates at the command points are variables and the variable values that achieve the best evaluation value are obtained. Hence, techniques generally used for multi-variable optimization may be used to obtain a tool orientation that achieves the best evaluation value. As an example of such techniques, the steepest descent method, the Nelder-Mead method, or the like is available.

### (Example Calculation of Evaluation Value)

As the evaluation value, at least one selected from an amount of drive axis movement, drive axis acceleration, energy consumption, and a machining time can be used. Examples of the calculation for the evaluation value are described below.

(1) when the Evaluation Value is a Total Amount of Axis Movement

The tool orientation correcting unit 22 can use a sum total of the amount of axis movement as the evaluation value for a tool path. A smaller total amount of movement can be expected to require less time and less energy for the movement. Thus, the tool orientation correcting unit 22 determines that a smaller evaluation value represents a better tool path in this case. An expression for the total amount of movement is provided below as Expression 1 (see [Expression 1]).

$$E = {\sum }_{i} {\sum }_{axis} {\{ Δ {L}_{axis} ( {p}_{i} ) \}}^{2} {w}_{axis} \qquad [ Expression 1 ]$$

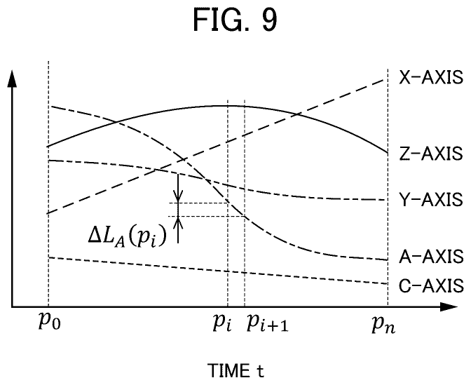

In Expression 1, axis represents a drive axis of a machine tool (for example, the linear axes X, Y, and Z, and the rotary axes A and C); ΔLaxis (pi) represents the amount of change of the axis (which is the drive axis represented by axis in Expression 1) from the first command point to the (i+1)th command point; and Waxis represents a weighting factor. The factor Waxis is set to a great value for an axis with great inertia or for an axis with a low maximum acceleration setting. FIG. 9 is a characteristic diagram showing ΔLaxis (pi). In FIG. 9, ΔL_{A} (pi) represents ΔLaxis (pi).
(2) when the Evaluation Value is Total Acceleration

The tool orientation correcting unit 22 can use a sum total of axis acceleration as the evaluation value for a tool path. Less acceleration can be expected to require less time or less energy for the acceleration/deceleration. Thus, the tool orientation correcting unit 22 determines that a smaller evaluation value represents a better tool path in this case. An expression for the total acceleration is provided below as Expression 2 (see [Expression 2] below).

$$E = {\sum }_{i} {\sum }_{axis} {\{ {Acc}_{axis} ( {p}_{i} ) \}}^{2} {w}_{axis} \\ {Acc}_{axis} ( {p}_{i} ) = ( \frac{Δ {L}_{axis} ( {p}_{i + 1} )}{Δ {t}_{i + 1}} - \frac{Δ {L}_{axis} ( {p}_{i} )}{Δ {t}_{i}} ) / Δ {t}_{i} \qquad [ Expression 2 ]$$

In Expression 2, Accaxis (pi) represents axis acceleration at the ith, and Waxis represents a weighting factor. The weighting factor Waxis is set to be greater for an axis having greater inertia or for an axis having less maximum acceleration setting.
(3) when the Evaluation Value is Total Energy Consumption

The tool orientation correcting unit 22 predicts machine energy consumption through simulation and uses the simulated machine energy consumption as the evaluation value. The tool orientation correcting unit 22 determines that less predicted energy consumption represents a better tool path. For the prediction of machine energy consumption, existing techniques can be used. For example, techniques described in Japanese Patent No. 4571225, Japanese Patent No. 4805329, and the like can be used.

(4) when the Evaluation Value is a Machining Time

The tool orientation correcting unit 22 can use a machining time as the evaluation value. For the machining time as the evaluation value, existing techniques include methods for predicting a machining time from NC programs (for example, Japanese Patent No. 06871207). Performing the inverse kinematic transformation on the second machine coordinate information MB provides a machining command, such as an NC command, describing the position and orientation of a tool with respect to the workpiece coordinate system, allowing prediction of the machining time. The tool orientation correcting unit 22 determines that a shorter predicted machining time represents a better tool path.

Note that, while examples have been described in which the first machine coordinate information MA includes time periods when a tool orientation should not be corrected and time periods when a tool orientation can be corrected, the methods for correcting a tool orientation can be applied to a case where the first machine coordinate information MA does not include a time period when the tool orientation should not be corrected.

### (Interference Calculating Unit)

The interference calculating unit 23 calculates an interference between a tool and a workpiece on the basis of the second machine coordinate information MB, the machine configuration information, tool shape information, and workpiece shape information. The interference calculating unit 23 performs the inverse kinematic transformation on each point of the machine coordinate information MB on the basis of machine situation information to calculate the position and orientation of the tool described with respect to the workpiece coordinate system. Then, the interference calculating unit 23 performs the coordinate transformation on the tool shape information to achieve the calculated tool position and tool orientation and calculates an interference between the tool shape subjected to the coordinate transformation and the workpiece shape. Interference calculation between pieces of shape data is a publicly known technique often used in a CAM device or the like.

The interference calculating unit 23 calculates an interference between the tool and the workpiece, and, if there is an interference, the interference calculating unit 23 finishes the processing and, if there is no interference, the interference calculating unit 23 outputs a corrected tool orientation to the machining command generating unit 24.

The machine configuration information is used for the inverse kinematic transformation. An example of the tool shape information may be any of the information listed below. Note, however, that the tool shape may include, not only the shape of the tool tip, but also the shape of the tooling or spindle if necessary to detect an interference. The tool shape information includes, for example, CAD data for a tool shape, parameter information of each height of the tool and a radius at each height and the like, and information that can represent the tool shape, such as an ISO standard (ISO 13399 and the like).

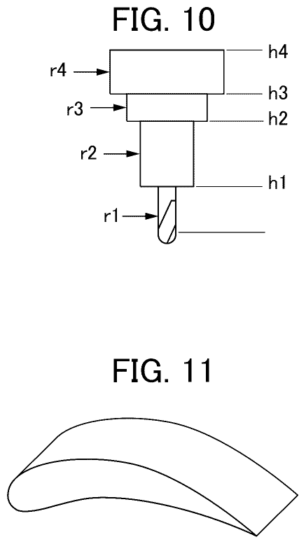

FIG. 10 is a diagram showing an example of the parameter information for each height of a tool and a radius at each height. In FIGS. 10, h1 to h4 represent heights and r1 to r4 represent radiuses at respective heights h1 to h4.

The workpiece shape information may be CAD data for a post-machining shape of a workpiece. FIG. 11 is a diagram showing CAD data as an example of the workpiece shape information.

### (Machining Command Generating Unit)

When the interference calculating unit 23 determines that there is no interference, the machining command generating unit 24 generates a machining command PB including the corrected tool orientation. While the machining command PB to be generated may have a format different from that of the machining command that has been input, it is reasonable that the format of the machining command PB be in agreement with that of the machining command that has been input.

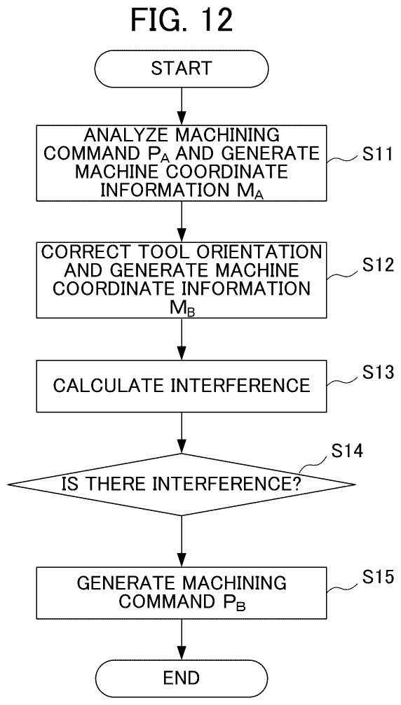

With reference to FIG. 12, an operation of the machining command correction device 20 (machining correction method) is described below. FIG. 12 is a flowchart showing the operation of the machining command correction device. At Step S11, the machining command analyzing unit 21 generates the first machine coordinate information MA, which is related to the machine coordinates of each control axis of a machine tool, on the basis of the first machining command PA, which is a pre-compensation machining command, and the machine configuration information.

At Step S12, the tool orientation correcting unit 22 corrects the orientation of a tool on the basis of the first machine coordinate information MA generated by the machining command analyzing unit 21, and generates the second machine coordinate information MB.

At Step S13, the interference calculating unit 23 calculates an interference between the tool and a workpiece on the basis of the second machine coordinate information MB, the machine configuration information, the tool shape information, and the workpiece shape information.

At Step S14, the interference calculating unit 23 calculates an interference between the tool and the workpiece. If there is an interference, the interference calculating unit 23 finishes the processing. If there is no interference, the interference calculating unit 23 provides an output to the machining command generating unit 24, which generates the second machining command PB including a corrected tool orientation. The operation proceeds to Step S15.

At Step S15, the machining command generating unit 24 generates the second machining command PB including the corrected tool orientation.

The present embodiment described above has an effect of being able to optimize a tool orientation without making a tool path obtained after a change in a tool orientation, less favorable than a tool path obtained before the change in the tool orientation, and within a range in which no interference occurs.

### First Modification Example

In the embodiment described above, if an interference is detected at a corrected tool orientation, the correction to the tool orientation is not performed. In the present modification example, if an interference is detected at a corrected tool orientation, correction is performed to achieve an optimal tool orientation within a range in which no interference occurs.

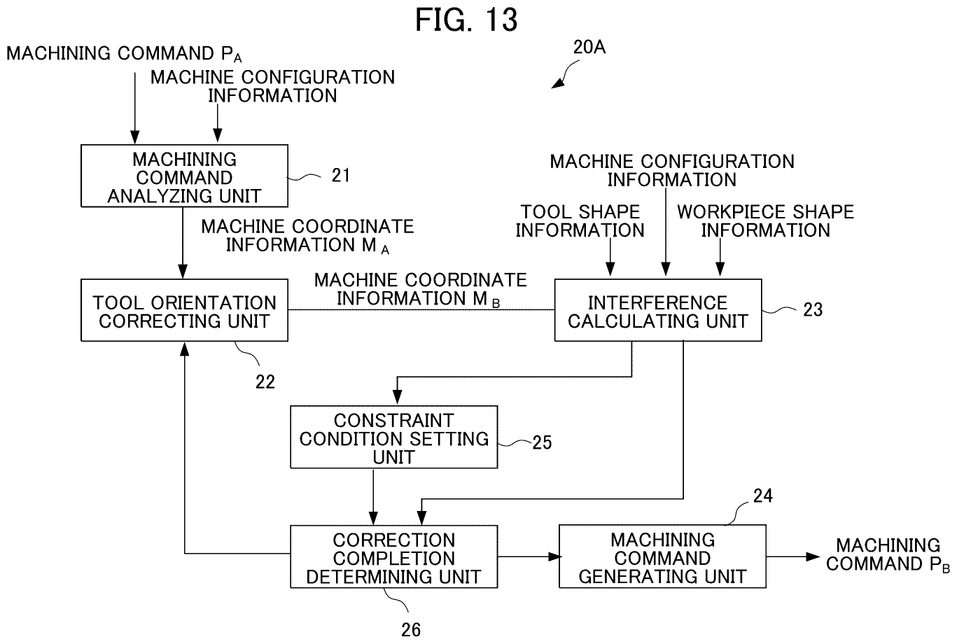

FIG. 13 is a block diagram showing a configuration of a machining command correction device according to a first modification example of the first embodiment of the present disclosure. A machining command correction device 20A shown in FIG. 13 further includes a constraint condition setting unit 25 and a correction completion determining unit 26, as compared to the machining command correction device 20 shown in FIG. 3. An operation of the machining command correction device 20A is the same as that of the machining command correction device 20, except those of the constraint condition setting unit 25 and the correction completion determining unit 26. The description for the same operation is omitted below.

The interference calculating unit 23 calculates an interference between the tool and the workpiece. If there is an interference, the interference calculating unit 23 outputs a corrected tool orientation to the constraint condition setting unit 25. If there is no interference, the interference calculating unit 23 outputs the corrected tool orientation to the correction completion determining unit 26, and the correction completion determining unit 26 outputs the corrected tool orientation to the machining command generating unit 24. Methods of correction to achieve an optimal tool orientation within a range in which no interference occurs by using the constraint condition setting unit 25 and the correction completion determining unit 26 include, for example, three methods (1) to (3) described below.

### (1) A Method of Gradually Correcting a Tool Orientation to Improve the Evaluation Value

If an interference occurs at a certain tool position on a tool path, processing (a) and processing (b) described below are performed.

(a) The constraint condition setting unit 25 resets the tool orientation at the tool position to an orientation given before the interference occurs and sets a limit (constraint condition) so that the tool orientation at this particular tool position does not further change. A change to get closer to the pre-compensation orientation may be permitted because it does not cause an interference. The correction completion determining unit 26 provides the tool orientation correcting unit 22 with a notification of incompletion that includes the constraint condition. The tool orientation correcting unit 22 attempts to correct the tool orientation under the constraint condition and, if the evaluation value further improves, continues to perform correction.

(b) If the correction completion determining unit 26 determines that correction has been repeated by a predefined number of times or that the evaluation value is not likely to become better than that obtained as of the present point of time by further changing the tool orientation, the correction completion determining unit 26 determines that the correction of the tool path has been completed and outputs a corrected tool orientation to the machining command generating unit 24. The determination that the evaluation value is not likely to become better than that obtained as of the present point of time can be performed by obtaining the evaluation values from the tool orientation correcting unit 22. The method (1) is suitable for cases where there are many interferences, and where a large degree of change cannot be made to the tool orientation.

(2) a Method of Calculating an Optimal Tool Path without Factoring Interference into the Calculation and Resetting a Tool Orientation at a Position where an Interference has Occurred

Calculation is performed without factoring interference into the calculation to obtain a tool orientation that achieves a best evaluation value. If an interference is detected at a tool position on the best tool path, processing of (a) and (b) described below is performed.

(a) The constraint condition setting unit 25 calculates a tool orientation that is intermediate between the pre-compensation tool orientation and the best tool orientation and that does not cause the tool to have an interference, and the constraint condition setting unit 25 resets the tool orientation to the calculated orientation. The constraint condition setting unit 25 sets a limit (constraint condition) so that the tool orientation at this particular tool position does not change further. Changes to get closer to the pre-compensation orientation may be permitted. The correction completion determining unit 26 provides the tool orientation correcting unit 22 with a notification of incompletion that includes the constraint condition. The tool orientation correcting unit 22 attempts to correct the tool orientation under the constraint condition and, if the evaluation value further improves, continues to perform correction.

(b) If correction has been repeated by a predefined number of times or an interference is not detected on the tool path having the best evaluation value at the present point of time, the correction completion determining unit 26 determines that the correction of the tool orientation has been completed and outputs the corrected tool orientation to the machining command generating unit 24. The method (2) is suitable for cases where interference hardly occurs when the orientation of the tool is changed to a large degree.

### (3) A Method Combining the Methods (1) and (2) Described Above

In an example, an optimal tool orientation is calculated as in the method (2), and, if an interference is detected, the tool orientation at the tool position where the interference occurs is reset to an orientation that does not have an interference. A limit (constraint condition) is also set so that the tool orientation at that position does not change further. Then, as in the method (1) described above, the tool orientation is gradually corrected to improve the evaluation value. In this case also, if the correction completion determining unit 26 determines that correction has been repeated by a predefined number of times or that the evaluation value is not likely to become better than that obtained as of the present point of time by further changing the tool orientation, the correction completion determining unit 26 determines that the correction of the tool path has been completed.

The present modification example has an effect of, in addition to the effect of the embodiment described above, being able to improve the efficiency of the optimization calculation using the methods described above in cases such as when a tool path includes positions having many interferences and positions having a few interferences.

### Second Modification Example

In the first modification example, when an interference is detected at a tool orientation obtained by the tool orientation correcting unit 22, the tool orientation is changed so that an interference does not occur. However, the changed tool orientation may result in a tool path evaluation value less favorable than that resulting from the tool orientation obtained by the tool orientation correcting unit. Instead of changing the tool orientation so that an interference does not occur, the present modification example changes a tool shape in such a way that an interference does not occur with the tool orientation obtained by the tool orientation correcting unit 22, allowing the use of the tool orientation having good evaluation.

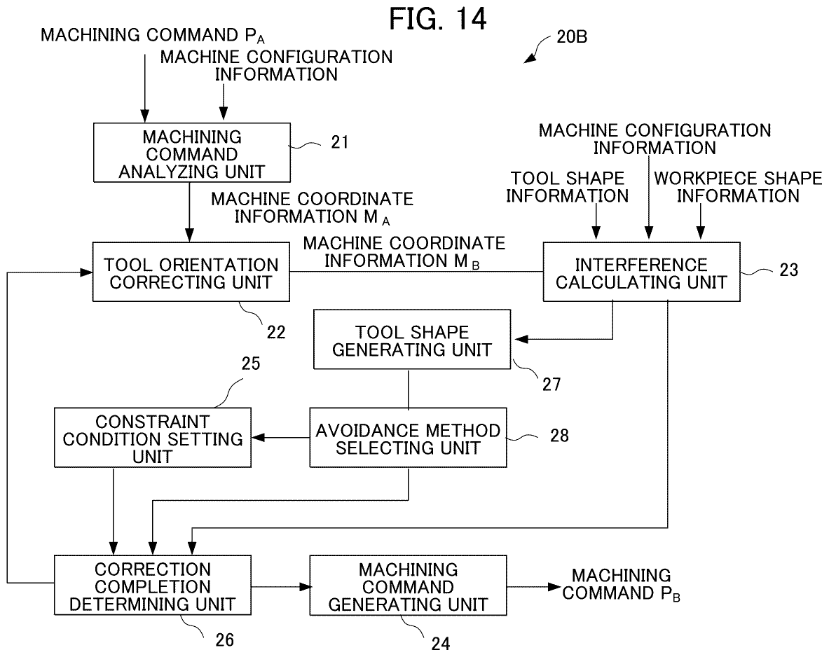

FIG. 14 is a block diagram showing a configuration of a machining command correction device according to a second modification example of the first embodiment of the present disclosure. A machining command correction device 20B shown in FIG. 14 further includes a tool shape generating unit 27 and an avoidance method selecting unit 28, as compared to the machining command correction device 20A shown in FIG. 13. Constituent elements of the machining command correction device 20B that are the same as those of the machining command correction device 20A have the same signs as those of the machining command correction device 20A, and description thereof is omitted.

The interference calculating unit 23 according to the second modification example has, not only the function of calculating an interference, but also a function of calculating a region on a tool shape, where the tool shape has an interference with a workpiece in the region. FIG. 15 is a diagram showing a region calculated by the interference calculating unit, where a tool shape has an interference with a workpiece in the region.

The tool shape generating unit 27 generates new tool shape information in which at least the interference region is removed from the tool shape and outputs the result to the avoidance method selecting unit 28. The avoidance method selecting unit 28 selects whether to change the tool path or to change the tool to one having the new tool shape in order to avoid the interference. If the avoidance method selecting unit 28 selects to avoid the interference by changing the tool shape, the tool shape information output by the interference calculating unit 23 is changed to the new tool shape information generated by the tool shape generating unit 27 and optimization processing is continued. If the avoidance method selecting unit 28 selects to avoid the interference by changing the tool path, operations using the constraint condition setting unit 25 and the correction completion determining unit 26 are performed as in the first modification example. Note that the tool shape generating unit 27 may be provided after the avoidance method selecting unit 28. In this case, if the avoidance method selecting unit 28 selects to avoid the interference by changing the tool shape, the tool shape generating unit 27 may generate the new tool shape information.

Methods for generating a new tool shape include a method of generating a tool shape on the basis of the tool shape information that has been input, so that the tool shape has a greater amount of protrusion of the tool, or a method of replacing a tooling portion in the tool shape information with one having a tooling shape with a smaller diameter.

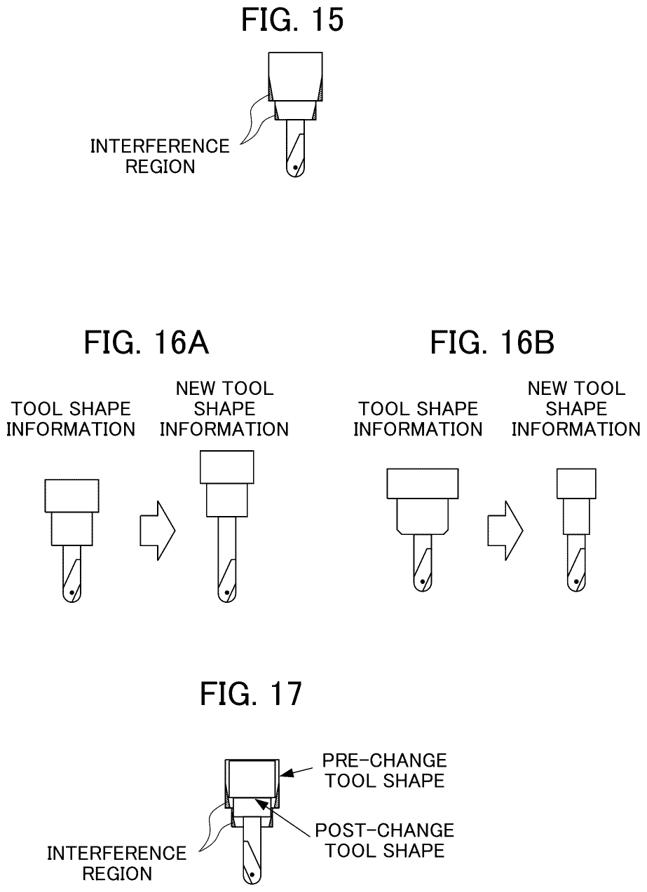

FIG. 16 (A) shows an example where the amount of protrusion of a tool is increased to generate new tool shape information. FIG. 16 (B) shows an example where a tooling portion in the tool shape information is replaced with one having a tooling shape with a smaller diameter to generate new tool shape information.

Selection at the avoidance method selecting unit 28 may be made by an operator, who then provides an instruction to the avoidance method selecting unit 28. Alternatively, the avoidance method selecting unit 28 may make the selection automatically. When the avoidance method selecting unit 28 makes the selection automatically, the avoidance method selecting unit 28, for example, automatically determines whether a new tool shape is appropriate as the tool shape and, if it is appropriate, selects to avoid an interference by changing the tool shape. FIG. 17 shows a case in which the tooling portion in the tool shape information is replaced with one having a tooling shape with a smaller diameter, so that the interference region is eliminated and there is no interference.

Determination of whether new tool shape information is appropriate as a tool shape may be performed separately. The determination may be made with methods including a method of determination with reference to a tool diameter and a length of protrusion, or a method of determination by calculating rigidity using FEM or the like.

In addition to the effect of the first modification example described above, the present modification example allows the use of a tool orientation having good evaluation by changing a tool shape.

### Third Modification Example

CAD data of a post-machining shape of a workpiece is input as the workpiece shape information in the embodiment, the first modification example, and the second modification example described above; however, CAD data may not be available in some cases. For example, while CAD data of a product final shape is available, CAD data of an in-progress shape of rough machining is not normally created. Thus, to correct a machining program by using the proposed techniques for purposes other than the final finishing, it is required to create CAD data of machining-in-progress shape for the detection of an interference.

As a method for creating such CAD data, machining simulation can be used. In the present modification example, machining simulation is performed, and an obtained shape is used as CAD data.

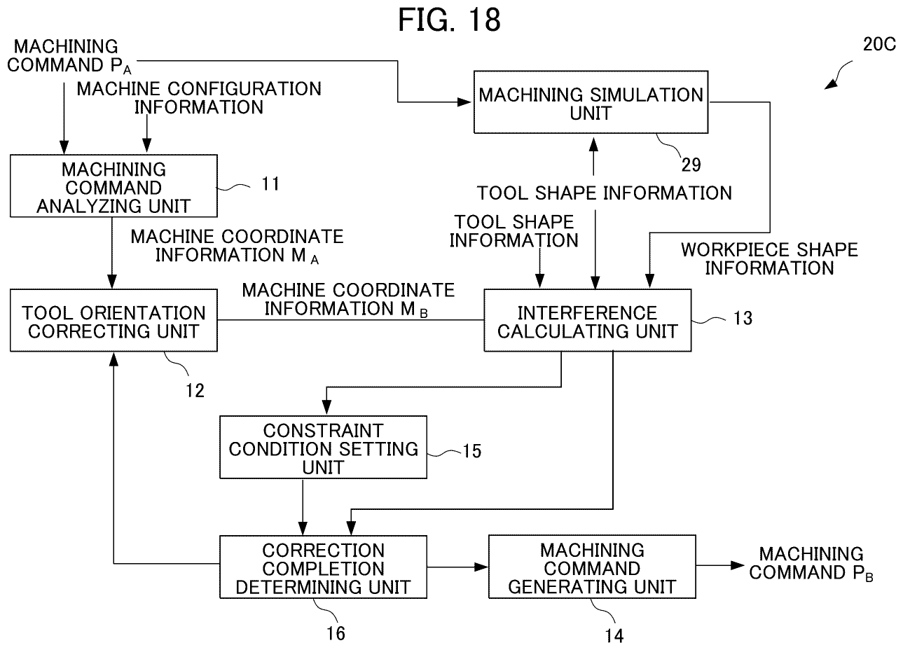

FIG. 18 is a block diagram showing a configuration of a machining command correction device according to a third modification example of the first embodiment of the present disclosure. A machining command correction device 20C shown in FIG. 18 further includes a machining simulation unit 29, as compared to the machining command correction device 20A shown in FIG. 13. Constituent elements of the machining command correction device 20C that are the same as those of the machining command correction device 20A have the same signs as those of the machining command correction device 20A, and description thereof is omitted.

In the modification example 3, the machining simulation unit 29 performs machining simulation by using the pre-correction machining command PA and the tool shape information, and outputs CAD data of an obtained shape to the interference calculating unit 23 as the workpiece shape information. Note that the present modification example can be applied to, not only the machining command correction device 20A according to the first modification example, but also the machining command correction device 20 according to the present embodiment and the machining command correction device 20B according to the second modification example.

The present modification example has an effect of, in addition to the effect of the first modification example described above, being able to correct a tool orientation when post-machining CAD data is unavailable.

### Second Embodiment

In the first embodiment and in the first to third modification examples, the interference calculating unit 23 calculates an interference using a particular tool orientation corrected by the tool orientation correcting unit 22.

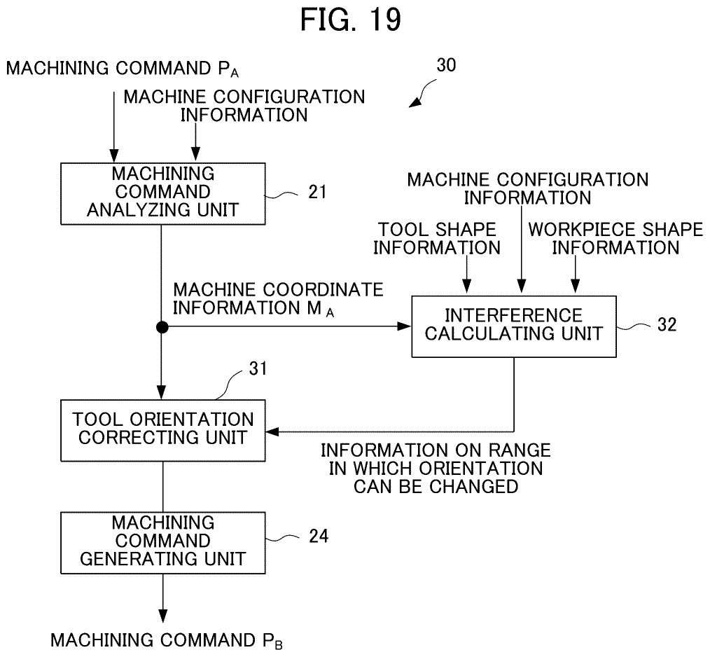

In the present embodiment, the interference calculating unit calculates a tool orientation range in which an interference does not occur, and the tool orientation correcting unit corrects a tool orientation within the calculated range. FIG. 19 is a block diagram showing a configuration of a machining command correction device according to the second embodiment of the present disclosure. A machining command correction device 30 shown in FIG. 19 includes a tool orientation correcting unit 31 and an interference calculating unit 32 instead of the tool orientation correcting unit 22 and the interference calculating unit 23 of the machining command correction device 20 shown in FIG. 3. Constituent elements of the machining command correction device 30 that are the same as those of the machining command correction device 20 have the same signs as those of the machining command correction device 20, and description thereof is omitted.

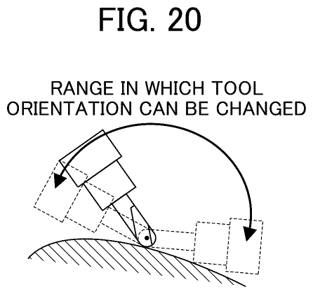

The interference calculating unit 32 checks for an interference on the basis of the machine coordinate information MA, the machine configuration information, the tool shape, and the workpiece shape. The interference calculating unit 32 calculates a range at each tool position, where an interference does not occur within the range when a tool orientation is changed from a pre-compensation tool orientation. FIG. 20 is a diagram showing the range in which the tool orientation can be changed without causing an interference. The tool orientation correcting unit 31 changes a tool orientation only within the calculated range, in which an interference does not occur, to correct the tool orientation. The tool orientation correcting unit 31 outputs the corrected tool orientation to the machining command generating unit 24.

The present embodiment may include the machining simulation unit 29 of the machining command correction device 20C described in the third modification example. In this case, the machining simulation unit 29 may perform machining simulation and output CAD data of a resulting shape, as the workpiece shape information, to the interference calculating unit 32.

The present embodiment has an effect of, in addition to the effect of the first embodiment described above, being able to reduce the calculation amount because the tool orientation correcting unit may correct a tool orientation only within a range in which no interference occurs.

To implement the constituent elements included in the machining command correction device in each embodiment and each modification example, the machining command correction device can be implemented by hardware, software, or a combination thereof. Here, the wording of being implemented by software means that the device is implemented by causing a computer to read and execute a program.

Specifically, the machining command correction device includes a processing unit, such as a CPU (Central Processing Unit), to implement the constituent elements included in the machining command correction device in each embodiment and each modification example by software or a combination thereof. The processing unit functions as an execution unit. The machining command correction device also includes: an auxiliary storage device, such as an HDD (Hard Disk Drive), that has stored therein various control programs, such as application software or an OS (Operating System); and a main storage device, such as a RAM (Random Access Memory), for storing data temporarily required for the processing unit to execute a program. The main storage device includes at least one selected from a memory area or a synchronous memory area.

In the machining command correction device, the processing unit reads the application software or the OS from the auxiliary storage device and, while loading the read application software or OS into the main storage device, performs processing based on the application software or the OS. On the basis of the result of the processing, the processing unit also controls various pieces of hardware included in the machining command correction device. In this way, the constituent elements of each embodiment and each modification example are implemented.

Each constituent element included in the machining command correction device can be implemented by hardware, including an electronic circuit and the like. When the machining command correction device is configured using hardware, some or all of the functions of each constituent element included in the machining command correction device can be configured using, for example, an integrated circuit (IC), such as an ASIC (Application Specific Integrated Circuit), a gate array, an FPGA (Field Programmable Gate Array), and a CPLD (Complex Programmable Logic Device).

A program can be stored using various types of non-transitory computer readable media and supplied to the computer. The non-transitory computer readable media include various types of tangible storage media. Examples of the non-transitory computer readable media include a magnetic recording medium (for example, a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EPROM (Erasable PROM), a flash ROM, and a RAM (random access memory)). A program may be supplied to the computer by using various types of transitory computer readable media.

At least one effect of at least one selected from the embodiments and modification examples described above is to be able to optimize a tool orientation without making a tool path obtained after a change in a tool orientation, less favorable than a tool path obtained before the change in the tool orientation, and within a range in which no interference occurs.

While the present disclosure is described above, the present disclosure is not limited to the individual embodiments and modification examples described above. Various additions, substitutions, modifications, partial deletions, and the like are possible for the embodiments and modification examples to the extent that does not depart from the spirit of the present disclosure or to the extent that does not depart from the spirit of the present disclosure derived from the claims and their equivalents. Furthermore, these embodiments and the modification examples can be implemented in combination. For example, the order of operation and the order of processing have been described merely as examples in the embodiments and modification examples described above, and the order of operation and the order of processing are not limited to these examples.

In relation to each embodiment and each modification example described above, the following supplements are further disclosed.

### (Supplement 1)

A machining command correction device (20, 20A, 20B, 20C) includes: a machining command analyzing unit (21) configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; a tool orientation correcting unit (22) configured to correct the orientation of the tool on the basis of the first machine coordinate information and generate second machine coordinate information; an interference calculating unit (23) configured to calculate an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and a machining command generating unit (24) configured to generate, when the interference does not exist, a second machining command on the basis of the second machine coordinate information, wherein the tool orientation correcting unit determines a corrected orientation of the tool by using an evaluation value for evaluating quality of a tool path.

### (Supplement 2)

The machining command correction device according to the supplement 1, wherein at least one selected from an amount of movement of a drive axis, acceleration of the drive axis, energy consumption, and a machining time that are to be achieved when machining is performed using the tool in accordance with the tool path, is used as the evaluation value.

### (Supplement 3)

The machining command correction device according to the supplement 1, further including: a constraint condition setting unit (25) configured to, when an interference is detected by the interference calculating unit, set a constraint condition related to a range of an allowed amount of change in the orientation of the tool; and a correction completion determining unit (26) configured to determine whether correction of the tool path under the constraint condition has been completed, wherein the tool orientation correcting unit generates the second machine coordinate information by correcting the first machine coordinate information within a limiting range imposed by the constraint condition.

### (Supplement 4)

The machining command correction device according to the supplement 3, wherein the interference calculating unit calculates an interference region of an interference between the tool having a shape in accordance with the tool shape information and the workpiece, the machining command correction device further includes: an avoidance method selecting unit (28) configured to, when an interference is detected by the interference calculating unit, select a method for avoiding the interference; and a tool shape generating unit (27) configured to, when an interference is detected by the interference calculating unit, generate new tool shape information from which the interference region has been removed, wherein the avoidance method selecting unit has at least two options for avoiding the interference between the tool having the shape in accordance with the tool shape information and the workpiece, the at least two options including: changing the tool path; and generating the new tool shape information, and when the avoidance method selecting unit selects to generate the new tool shape information, the tool orientation correcting unit corrects the orientation of the tool by using a tool having the new tool shape information on the basis of the first machine coordinate information and generates the second machine coordinate information.

### (Supplement 5)

The machining command correction device according to the supplement 1, further including a machining simulation unit (29) configured to generate the workpiece shape information on the basis of the first machining command and the tool shape information.

### (Supplement 6)

A machining command correction device including: a machining command analyzing unit (21) configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; an interference calculating unit (32) configured to calculate an interference between the tool and the workpiece for a case in which the machine tool operates in accordance with the first machine coordinate information, on the basis of the first machine coordinate information, the machine configuration information, tool shape information related to a shape of the tool for use in machining to be performed in accordance with the first machining command, and workpiece shape information related to a shape of the workpiece to be achieved when the first machining command is performed; a tool orientation correcting unit (31) configured to correct the orientation of the tool on the basis of the first machine coordinate information and generate second machine coordinate information; and a machining command generating unit (24) configured to generate, when the interference does not exist, a second machining command on the basis of the second machine coordinate information, wherein the interference calculating unit calculates a tool orientation range in which an interference does not occur, and the tool orientation correcting unit corrects the orientation of the tool within the tool orientation range that has been calculated, and determines a corrected orientation of the tool by using an evaluation value for evaluating quality of a tool path.

### (Supplement 7)

A machining command correction method including causing a computer as a machining command correction device (20, 20A, 20B, 20C) to perform processing that includes: generating first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof; correcting the orientation of the tool on the basis of the first machine coordinate information and generating second machine coordinate information; calculating an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and generating, when the interference does not exist, a second machining command on the basis of the second machine coordinate information.

### EXPLANATION OF REFERENCE NUMERALS

10 data generation system
11 CAM device
12 CNC device 12
20, 20A, 20B, 20C, 30 machining command correction device
21 machining command analyzing unit
22, 31 tool orientation correcting unit
23, 32 interference calculating unit
24 machining command generating unit
25 constraint condition setting unit
26 correction completion determining unit
27 tool shape generating unit
28 avoidance method selecting unit
29 machining simulation unit

1. A machining command correction device comprising:
a machining command analyzing unit configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof;
a tool orientation correcting unit configured to correct the orientation of the tool on the basis of the first machine coordinate information and generate second machine coordinate information;
an interference calculating unit configured to calculate an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and
a machining command generating unit configured to generate, when the interference does not exist, a second machining command on the basis of the second machine coordinate information,
wherein the tool orientation correcting unit determines a corrected orientation of the tool by using an evaluation value for evaluating quality of a tool path.

2. The machining command correction device according to claim 1, wherein at least one selected from an amount of movement of a drive axis, acceleration of the drive axis, energy consumption, and a machining time that are to be achieved when machining is performed using the tool in accordance with the tool path, is used as the evaluation value.

3. The machining command correction device according to claim 1, further comprising:
a constraint condition setting unit configured to, when an interference is detected by the interference calculating unit, set a constraint condition related to a range of an allowed amount of change in the orientation of the tool; and
a correction completion determining unit configured to determine whether correction of the tool path under the constraint condition has been completed,
wherein the tool orientation correcting unit generates the second machine coordinate information by correcting the first machine coordinate information within a limiting range imposed by the constraint condition.

4. The machining command correction device according to claim 3, wherein
the interference calculating unit calculates an interference region of an interference between the tool having a shape in accordance with the tool shape information and the workpiece,
the machining command correction device further comprises:
an avoidance method selecting unit configured to, when an interference is detected by the interference calculating unit, select a method for avoiding the interference; and
a tool shape generating unit configured to, when an interference is detected by the interference calculating unit, generate new tool shape information related to a new tool shape from which the interference region has been removed,
wherein
the avoidance method selecting unit has at least two options for avoiding the interference between the tool having the shape in accordance with the tool shape information and the workpiece,
the at least two options comprising: changing the tool path; and generating the new tool shape information, and
when the avoidance method selecting unit selects to generate the new tool shape information, the tool orientation correcting unit corrects the orientation of the tool by using a tool having the new tool shape information on the basis of the first machine coordinate information and generates the second machine coordinate information.

5. The machining command correction device according to claim 1, further comprising: a machining simulation unit configured to generate the workpiece shape information on the basis of the first machining command and the tool shape information.

6. A machining command correction device comprising:
a machining command analyzing unit configured to generate first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof;
an interference calculating unit configured to calculate an interference between the tool and the workpiece for a case in which the machine tool operates in accordance with the first machine coordinate information, on the basis of the first machine coordinate information, the machine configuration information, tool shape information related to a shape of the tool for use in machining to be performed in accordance with the first machining command, and workpiece shape information related to a shape of the workpiece to be achieved when the first machining command is performed;
a tool orientation correcting unit configured to correct the orientation of the tool on the basis of the first machine coordinate information and generate second machine coordinate information; and
a machining command generating unit configured to generate, when the interference does not exist, a second machining command on the basis of the second machine coordinate information,
wherein
the interference calculating unit calculates a tool orientation range in which an interference does not occur, and
the tool orientation correcting unit corrects the orientation of the tool within the tool orientation range that has been calculated, and determines a corrected orientation of the tool by using an evaluation value for evaluating quality of a tool path.

7. A machining command correction method comprising causing a computer as a machining command correction device to perform processing that comprises:
generating first machine coordinate information that is a time-series change in coordinates of each axis of a machine tool on a basis of a first machining command that describes time-series change in position and orientation of a tool, and machine configuration information for performing coordinate transformation between a coordinate system having a workpiece as a reference thereof and a coordinate system having the machine tool as a reference thereof;
correcting the orientation of the tool on the basis of the first machine coordinate information and generating second machine coordinate information;
calculating an interference between the tool and the workpiece for a case in which the machine tool operates in accordance with the second machine coordinate information, on the basis of the second machine coordinate information, the machine configuration information, tool shape information related to a shape of the tool for use in machining to be performed in accordance with the first machining command, and workpiece shape information related to a shape of the workpiece to be achieved when the first machining command is performed; and
generating, when the interference does not exist, a second machining command on the basis of the second machine coordinate information.
